(19) United States
(12) Patent Application Publication
(10) Pub. No.: US 2003/0235252 A1
(43) Pub. Date: Dec. 25, 2003

(54) Method and system of biasing a timing phase estimate of data segments of a received signal

(76) Inventors: Jose Tellado, Sunnyvale, CA (US); John Dring, San Jose, CA (US)

Correspondence Address: Patent Department, Iospan Wireless, P.O. Box 641867, San Jose, CA, 95164-1867, US

(21) Appl. No.: 10/176,300

(22) Filed: Jun. 19, 2002

(51) Int. Cl. H04L 27/00

(52) U.S. Cl. 375/259

(57) ABSTRACT

The present invention provides a method and system for biasing a timing phase estimate of data segments of a received wireless signal. The method includes receiving the wireless signal. A timing phase estimate of the data segments of the wireless signal is pre-set depending upon a phase estimator estimate. The timing phase estimate of the data segments of the wireless signal is further biased as a function of a quality parameter of the wireless signal. The data segments are processed generating a receiving data stream.

### FILED OF THE INVENTION

The invention relates generally to a communications receiver. More particularly, the invention relates to a method and system of biasing a timing phase estimate of data segments of a received signal.

### BACKGROUND OF THE INVENTION

Wireless communication systems commonly include information-carrying modulated carrier signals that are wirelessly transmitted from a transmission source (for example, a base transceiver station) to one or more receivers (for example, subscriber units) within an area or region.

A Wireless Channel

FIG. 1 shows modulated carrier signals traveling from a transmitter 110 to a receiver 120 following many different (multiple) transmission paths.

Multipath can include a composition of a primary signal plus duplicate or echoed images caused by reflections of signals off objects between the transmitter and receiver. The receiver may receive the primary signal sent by the transmitter, but also receives secondary signals that are reflected off objects located in the signal path. The reflected signals arrive at the receiver later than the primary signal. Due to this misalignment, the multipath signals can cause intersymbol interference or distortion of the received signal.

The actual received signal can include a combination of a primary and several reflected signals. Because the distance traveled by the original signal is shorter than the reflected signals, the signals are received at different times. The time difference between the first received and the last received signal is called the delay spread and can be as great as several micro-seconds.

The multiple paths traveled by the modulated carrier signal typically results in fading of the modulated carrier signal. Fading causes the modulated carrier signal to attenuate in amplitude when multiple paths subtractively combine.

Transmission signals of a wireless system can include streams of digital bits of information. The digital streams are generally broken up into data segments or data packets of information. FIG. 2A shows a data segment traveling three different (multiple) paths. Each data segment 210, 212, 214 is received at a different time depending upon the signal path the data segment 210, 212, 214 travels.

Data processing of the data segments 210, 212, 214 by the receiver requires the receiver to be synchronized with the received data segments 210, 212, 214. Synchronization can be accomplished by including a unique, identifiable bit sequence within the data segments that the receiver can recognize. The receiver can use the unique, identifiable bit sequence for determination of when the data segments 210, 212, 214 begin and end. This aids in the processing of the data segments 210, 212, 214.

However, the data segments 210, 212, 214 of FIG. 2A arrive at the receiver at varied time. Therefore, inclusion of a unique, identifiable bit sequence within the data segments 210, 212, 214 may not necessarily provide the best determination of when the data segments begin and end. Arrow 240 is a potential sampling point by the receive that might be provided by bit sequence. This can correspond to the reception time of the first data segment 210.

FIG. 2B shows another set of data segments 220, 222, 224 traveling three (multiple) transmission paths. Unlike the data segments 210, 212, 214 of FIG. 2A, the data segment 220 received first does not have the maximum received signal amplitude. The data segment 222 received second has the greatest received signal amplitude. Generally, this makes the processing of the data segments 220, 222, 224 even more complicated. Arrow 250 shows a potential sampling point by the receiver for the data segments 220, 222, 224 of FIG. 2B.

Transmission signals having greater bandwidth are more susceptible to the effects of multi-path. Therefore, wide bandwidth wireless systems are more likely to suffer from poor receiver synchronization to received data segments.

It is desirable to have a method and system for additionally adjusting the phase timing offset of data segments of received signals. The method and system should be adaptable to operation with multiple transmitter systems, and multiple receiver systems. Additionally, the method and system should be adaptable for use with multiple carrier systems.

### SUMMARY OF THE INVENTION

The invention includes a method and system for adjusting the phase timing offset of data segments of received signals. The method and system is adaptable to operation with multiple transmitter systems, and multiple receiver systems.

A first embodiment of the invention includes a method of biasing a timing phase estimate of data segments of a received wireless signal. The method includes receiving the wireless signal. A timing phase estimate of the data segments of the wireless signal is pre-set depending upon a phase estimator estimate. The timing phase estimate of the data segments of the wireless signal is further biased as a function of a quality parameter of the wireless signal. The data segments are processed generating a receiving data stream.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless system that includes multiple paths from a system transmitter to a system receiver.

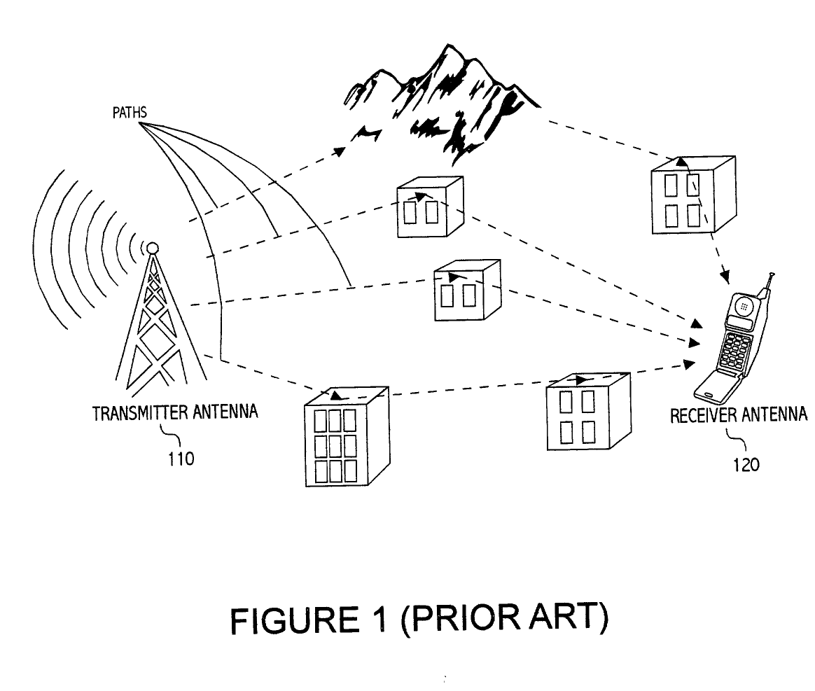

FIGS. 2A and 2B show a reception time of data segments that have traveled multiple transmission paths.

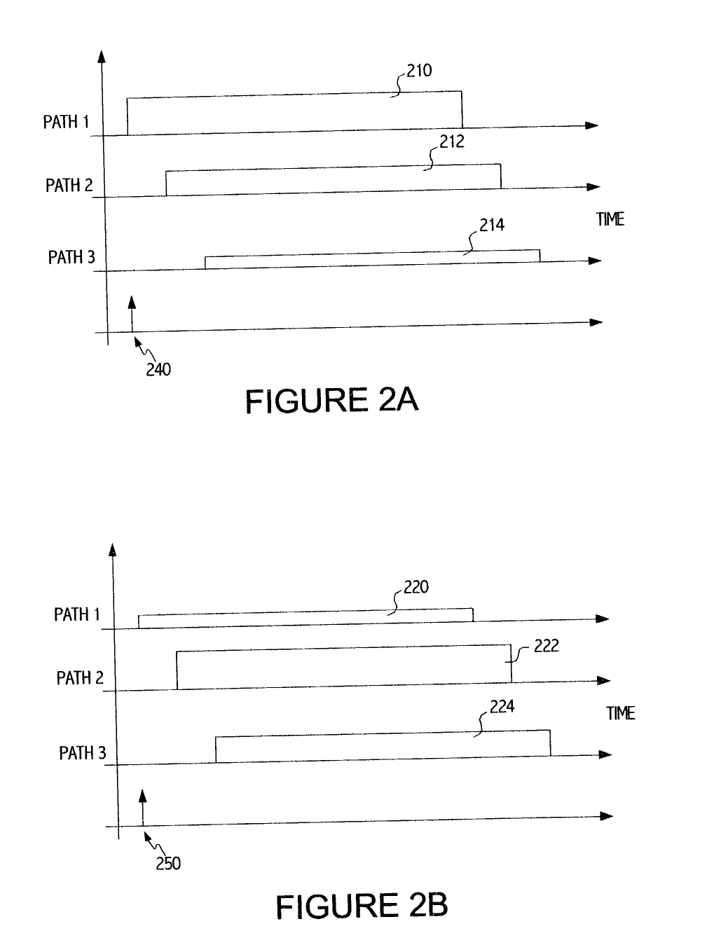

FIG. 3 shows an embodiment of the invention.

FIG. 4 shows an example of an energy distribution profile of a received wireless signal.

FIG. 5 show another embodiment of the invention.

FIG. 6 shows another embodiment of the invention.

FIG. 7 shows another embodiment of the invention that includes multiple transmitting base stations.

FIG. 8 shows a flow chart of steps or acts included within an embodiment of the invention.

FIG. 9 shows a flow chart of steps or acts included within another embodiment of the invention.

### DETAILED DESCRIPTION

As shown in the drawings for purposes of illustration, the invention is embodied in a method and system for adjusting the phase timing offset of data segments of received signals. The method and system is adaptable to operation with multiple transmitter systems, and multiple receiver systems.

Particular embodiments of the present invention will now be described in detail with reference to the drawing figures. The techniques of the present invention may be implemented in various different types of wireless communication systems. Of particular relevance are cellular wireless communication systems. A base station transmits downlink signals over wireless channels to multiple subscribers. In addition, the subscribers transmit uplink signals over the wireless channels to the base station. Thus, for downlink communication the base station is a transmitter and the subscribers are receivers, while for uplink communication the base station is a receiver and the subscribers are transmitters. Subscribers may be mobile or fixed. Exemplary subscribers include devices such as portable telephones, car phones, and stationary receivers such as a wireless modem at a fixed location.

The base station can be provided with multiple antennas that allow antenna diversity techniques and/or spatial multiplexing techniques. In addition, each subscriber can be equipped with multiple antennas that permit further spatial multiplexing and/or antenna diversity. Single Input Multiple Output (SIMO), Multiple Input Single Output (MISO) or Multiple Input Multiple Output (MIMO) configurations are all possible. In either of these configurations, the communications techniques can employ single-carrier or multi-carrier communications techniques. Although the techniques of the present invention apply to point-to-multipoint systems, they are not limited to such systems, but apply to any wireless communication system having at least two devices in wireless communication. Accordingly, for simplicity, the following description will focus on the invention as applied to a single transmitter-receiver pair, even though it is understood that it applies to systems with any number of such pairs.

Point-to-multipoint applications of the invention can include various types of multiple access schemes. Such schemes include, but are not limited to, time division multiple access (TDMA), frequency division multiple access (FDMA), code division multiple access (CDMA), orthogonal frequency division multiple access (OFDMA) and wavelet division multiple access.

The transmission can be time division duplex (TDD). That is, the downlink transmission can occupy the same channel (same transmission frequency) as the uplink transmission, but occur at different times. Alternatively, the transmission can be frequency division duplex (FDD). That is, the downlink transmission can be at a different frequency than the uplink transmission. FDD allows downlink transmission and uplink transmission to occur simultaneously.

Typically, variations of the wireless channels cause uplink and downlink signals to experience fluctuating levels of attenuation, interference, multi-path fading and other deleterious effects. In addition, the presence of multiple signal paths (due to reflections off buildings and other obstacles in the propagation environment) causes variations of channel response over the frequency bandwidth, and these variations may change with time as well. As a result, there are temporal changes in channel communication parameters such as data capacity, spectral efficiency, throughput, and signal quality parameters, e.g., signal-to-interference and noise ratio (SINR), and signal-to-noise ratio (SNR).

Information is transmitted over the wireless channel using one of various possible transmission modes. For the purposes of the present application, a transmission mode is defined to be a particular modulation type and rate, a particular code type and rate, and may also include other controlled aspects of transmission such as the use of antenna diversity or spatial multiplexing. Using a particular transmission mode, data intended for communication over the wireless channel is coded, modulated, and transmitted. Examples of typical coding modes are convolution and block codes, and more particularly, codes known in the art such as Hamming Codes, Cyclic Codes and Reed-Solomon Codes. Examples of typical modulation modes are circular constellations such as BPSK, QPSK, and other m-ary PSK, square constellations such as 4QAM, 16QAM, and other m-ary QAM. Additional popular modulation techniques include GMSK and m-ary FSK. The implementation and use of these various transmission modes in communication systems is well known in the art.

For channels with significant delay-spread, typically orthogonal frequency division multiplexing (OFDM) modulation system (as will be described later) can be employed. In an OFDM system that includes multiple frequency tones, the delay spread results in each frequency tone having a different fade.

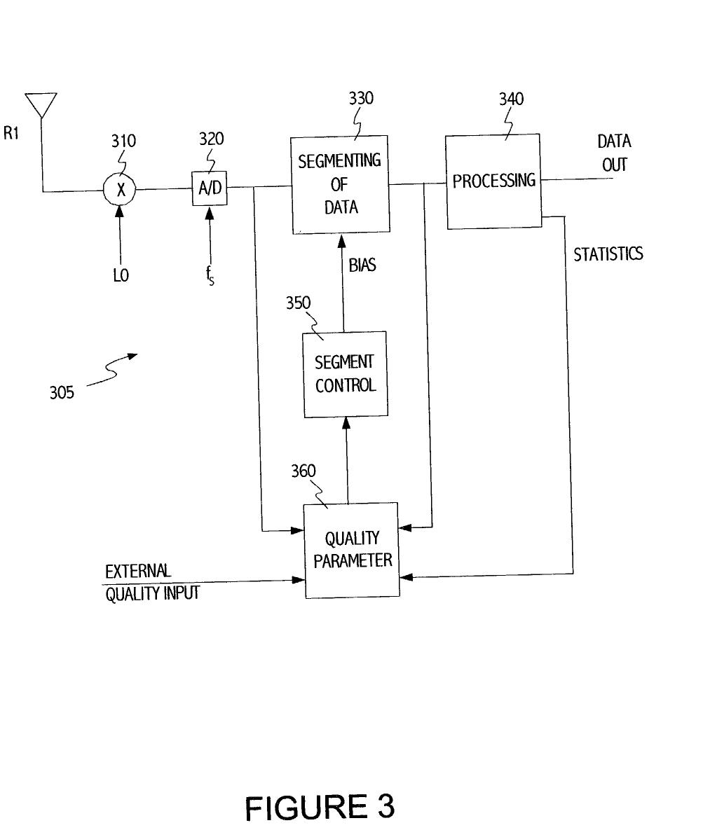

FIG. 3 shows an embodiment of the invention. This embodiment includes a receiver chain 305. The receiver chain 305 generally includes a receiver antenna R1, a frequency down-converter 310 and an analog to digital converter (ADC) 320.

The receiver antenna R1 generally receives transmission signals that include digital information (data segments).

The frequency down-converter 310 is generally a mixer that frequency down-converts the received signal with a local oscillator (LO) signal, generating a base band or low intermediate frequency (IF) signal. The LO signal is typically phase-locked to a reference oscillator within the receiver. Embodiments of the invention could include removal of the frequency down-converter 310.

The ADC 320 converts the analog base band signal to a digital signal consisting of a stream of digital bits. A predetermined number of digital bits make up data segments.

A processor 340 processes the received streams of digital bits. Generally, the processing includes demodulating and decoding the bit stream to yield an estimated received data stream.

A data segmenting unit 330 controls the segmentation of the stream of received digital bits. Generally, the segment controller initially segments the stream of data bits. The initial segmentation can be based upon a segmentation process as previously described. More specifically, the initial segmentation can be based upon the detection of a unique structure within the stream of data bits. The unique structure can be a known pattern of bits. However, as previously described, the processing of the data bits can be difficult in multi-path environments because the receiver receives several versions of the transmitted signals at different points in time.

A BIAS control line connected to the data segmenting unit 330 additionally biases the starting points of the data segments produced by the data segmenting unit 330. The BIAS control line is controlled by a segment controller 350.

Generally, the receiver chain 305 receives a wireless signal. A timing phase estimate of the data segments of the wireless signal is pre-set depending upon a phase estimator estimate. The timing phase estimate of the data segments of the wireless signal are further biased as a function of a quality parameter of the wireless signal. The data segments are processed generating a receiving data stream.

Generally, the segment controller 350 is influenced by a quality parameter of the received signals generated by quality parameter block 360. Quality parameters of the received signals that can be used to influence the segment controller 350 include signal to noise ratio (SNR), channel delay profile, doppler spread, data segment phase estimate, a data segment phase algorithm, an equalizer length, cyclic prefix length, coding bandwidth, a modulation bandwidth, bit error rate (BER), packet error rate (PER) or error detection/correction codes.

The segment controller 350 can also be influenced by prior knowledge of the wireless system and the wireless system environment. The prior knowledge can include pre-characterization of the transmission channel or knowledge of the environment in which the wireless signals are transmitted. This prior knowledge provides useful information regarding the quality of the received signals.

A transmitter can provide the receiving chain 305 with a quality parameter. The transmitter provided quality parameter can be included with down stream transmission to the receiving chain 305. Such a quality parameter is designated as an external quality parameter in FIG. 3.

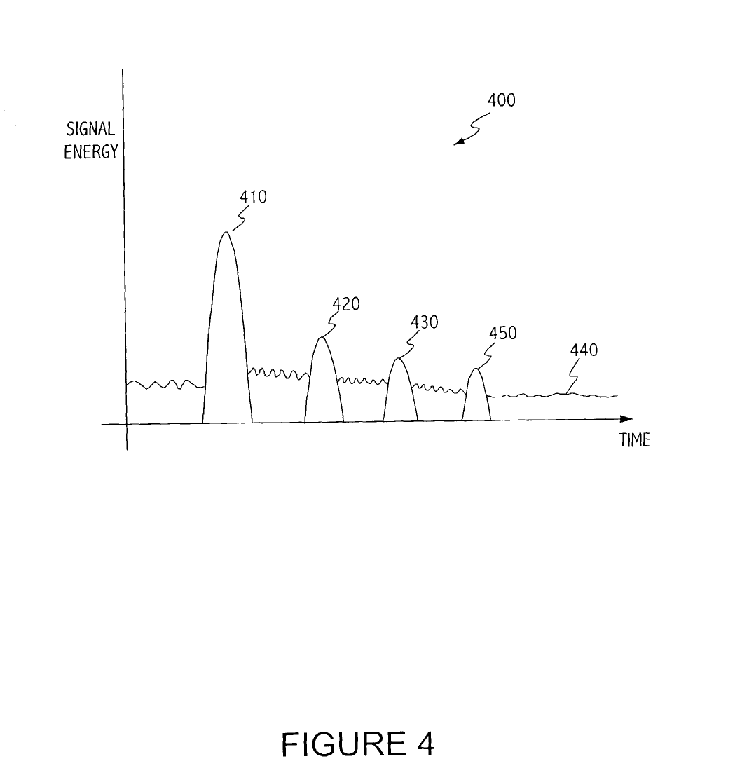

FIG. 4 shows an example of an energy distribution profile 400 of a received wireless signal. This profile depicts three energy peaks 410, 420, 430 that represent three different multi-paths traveled by a wireless signal through a transmission path. A proper data segment bias provides maximal processed signal energy.

In addition to the three desired energy peaks 410, 420 and 430, the received energy includes undesired noise and distortion (440) and interference (450). Proper data segmentation provides maximal processed signal energy while minimizing the degradation effects of noise, distortion and interference.

To maximize the quality of the processed signal, the desired signal must be carefully extracted from the unwanted signals. Extraction of the desired signal can be implemented in multiple forms and depends heavily on the specific modulation and the receiver design. In general, some form of windowing or filtering operation is necessary in the channel estimation and/or equalization stages. The parameters of this processing inherently select the time span over which the desired signal is extracted, and the data segmentation selects the “center” of this time span. Examples of processing algorithms that select the time span include the length of an equalizer for single carrier systems and length of a CP, training tone separation and channel estimation filter for multi-carrier systems.

Generally, timing phase estimators select a segmentation point based on a simple criteria, such as maximum desired signal energy peak or center of mass of energy delay profile. If the receiver segments the data based on one of these simple criteria, the processing time span will often miss significant desired multi-path energy. This disregarded energy often becomes additional distortion. On the other hand, if quality parameters such as the delay profile, distortion level, doppler, etc. are known, the phase estimator can be biased correctly to include all the desired energy.

For example in FIG. 4, if an estimate of the average energy and location of the three desired energy peaks is known, as well as the noise and distortion level, the receiver can make a decision to set a time span that is long enough to span all three paths. Moreove, if the timing phase estimator is based on center of mass of energy delay profile, the bias can be set as the difference between the center of mass of the energy and the center of the three paths.

In another embodiment the doppler spread of each path is known, and the smallest path is reflected from a very fast moving reflector that is hard to estimate accurately. Moreover, the receiver must process a low order modulation or a strong error correction code which requires a lower signal noise to distortion ratio (SNDR). The receiver can set the time span to include only the first two paths, and the bias will be the difference between the center of mass and the time center of the two stronger paths.

In another embodiment, the receiver does not have the desired energy delay profile, but does have the preprocessing SNDR and post-processing SNDR or BER. The receiver has prior knowledge that indicates the phase estimator typically select the strongest path. Typically, in a wireless channel the first path is the strongest. In this scenario, the bias should be a number greater than zero. This bias can be modified in a control loop to maximize the post processing SNDR values.

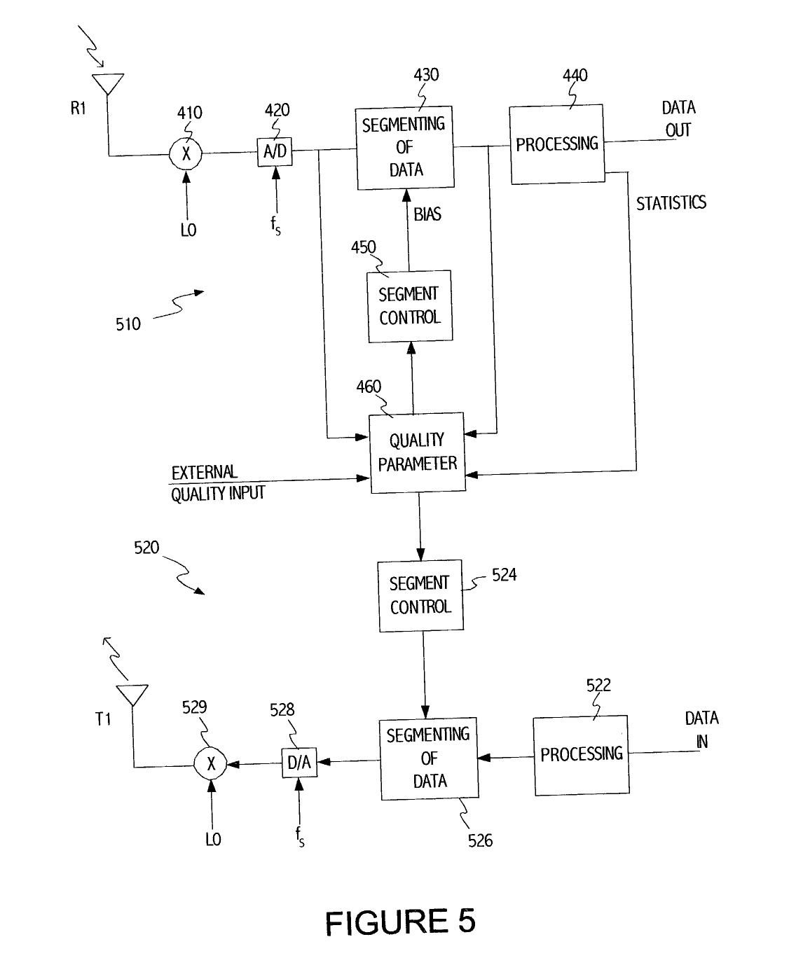

FIG. 5 shows an embodiment of the invention that includes a receiving chain 510 and a transmission chain 520.

The transmission chain 520 receives a stream of data (DATA IN) for transmission. A processing unit 522 processes the received data stream. The processing can include coding, spatial processing and/or diversity processing.

A segmenting unit 526 provides control over segmenting the data stream before transmission. A segment control unit 524 provides the segmenting controls.

The quality parameter block 560 can influence the segment controls.

Depending upon the reciprocity of the transmission channel, the reception segment control can advantageously influence the transmission segmentation. That is, if the transmission channel, for example, is equivalent for up link transmission and down link transmission, then the bias control of the data segments for up link transmission and down link transmission will be related, and quality parameters generated in either direction can be used to adjust the phase bias in the other direction.

Reciprocity of the transmission channel can also allow a transmitter to provide the receiving chain 510 with a quality parameter. The transmitter provided quality parameter can be included with down stream transmission to the receiving chain 510.

The transmission chain 520 includes a digital to analog converter 528 (DAC) for converting the segmented digital bit stream into analog signals.

A frequency up-conversion is generally implemented with a frequency mixer 529 that is driven by an LO.

The biasing the phase of the data segments of the wireless signal as a function of a quality parameter of the wireless signal can be additionally used by a transceiver receiving the wireless signals to adjust transmit timing phase estimates of transmit data segments being transmitted by the transceiver. That is, quality parameters generated by signals received by a transceiver can additionally be used for bias adjustment of data segments being transmitted by the transceiver.

Multiple Chain Systems

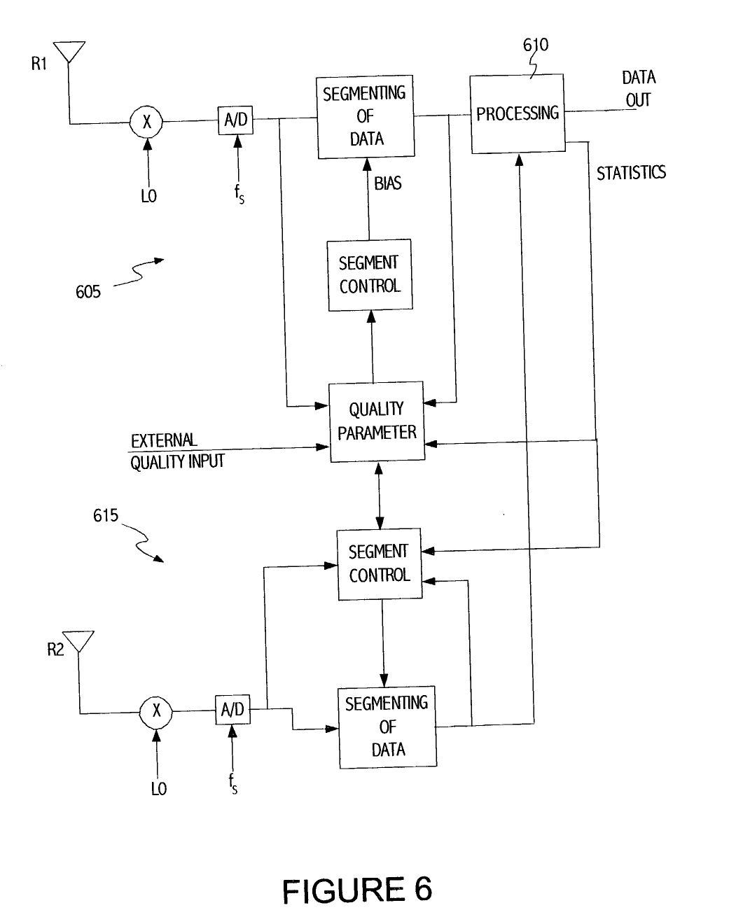

FIG. 6 shows a receiver that includes multiple receiver chains 605, 615. The multiple receiver chains 605, 615 allow for spatial multiplexing and diversity reception.

A first chain 605 receives transmission signals through a first antenna R1. A second chain 615 receives transmission signals through a second antenna R2.

Spatial multiplexing is a transmission technology that exploits multiple antennae at both the base transceiver station and at the subscriber units to increase the bit rate in a wireless radio link with no additional power or bandwidth consumption. Under certain conditions, spatial multiplexing offers a linear increase in spectrum efficiency with the number of antennae.

The composite transmission signals are captured by the receiving antennae having random phase and amplitudes. At the receiver array, a spatial signature of each of the received signals is estimated. Based on the spatial signatures, a signal processing technique is applied to separate the signals, recovering the original substreams.

Multiple antenna systems can employ spatial multiplexing to improve data rates. In such schemes, multiple transmit signals are sent over separate antennas to obtain a linear increase in data rates. Spatial multiplexing schemes require no channel knowledge at the transmitter, but suffer performance loss in poor transmission quality channels. Poor transmission quality channels include properties that null out or attenuate some elements of the transmit signals. As a result, the receiver receives a badly distorted copy of the transmit signal and suffer performance loss. There is a need for additional transmit preprocessing schemes that assume channel knowledge and mitigate performance loss in poor transmission quality channels.

Antenna diversity is a technique used in multiple antenna-based communication system to reduce the effects of multi-path fading. Antenna diversity can be obtained by providing a transmitter and/or a receiver with two or more antennae. Each transmit and receive antenna pair include a transmission channel. The transmission channels fade in a statistically independent manner. Therefore, when one transmission channel is fading due to the destructive effects of multi-path interference, another of the transmission channels is unlikely to be suffering from fading simultaneously. By virtue of the redundancy provided by these independent transmission channels, a receiver can often reduce the detrimental effects of fading.

The received information signals can be transmitted from a transmitter that includes k spatial separate streams. Generally, such a transmitter applies an encoding mode to each of the k streams to encode the data to be transmitted. Before transmission, the data may be interleaved and pre-coded. Interleaving and pre-coding are well known in the art of communication systems. The transmission rate or throughput of the data varies depending upon the modulation, coding rates and transmission scheme (diversity or spatial multiplexing) used in each of the k streams.

A processing block 610 includes demodulation and spatial processing to recover the k encoded streams. The recovered k streams are signal detected, decoded and de-multiplexed for recovery the data. In the case of antenna diversity processing, it should be understood that k is equal to one and thus there is only a single stream recovered.

The multiple chain receiver receives a plurality of wireless signals through a plurality of receiver chains, each wireless signal having traveled through a corresponding transmission channel. A timing phase estimate of the data segments of the each of the wireless signals are pre-set depending upon a phase estimator estimate. The timing phase estimate of the data segments of each of the wireless signal are further biased as a function of a quality parameter of each of the wireless signals. The data segments are processed generating a receiving data stream.

The quality parameters can include signal to noise ratio (SNR), channel delay profile, doppler spread, data segment phase estimate, bit error rate (BER), packet error rate (PER) or error detection/correction codes. Because there are multiple receiver chains, the quality parameter generally is in the form of a vector.

The timing phase estimates of the data segments of each wireless signal can be biased separately. Alternatively, the timing phase estimates of the data segments of all the received wireless signal can be biased with the same timing phase estimate.

The quality parameter that determines the biasing of the timing phase, can be a function of a composite of signal quality of the plurality of the received signals. Alternatively or additionally, the quality parameter can be a function of a corresponding received signal.

The timing phase estimate of received signals can be additionally biased as a function of whether the transmission includes spatial multiplexing, and/or transmit diversity.

The processing can include only processing the wireless signals that include a quality parameter having a threshold value of quality. For example, diversity transmission can include only receiving the signals that include a certain threshold value of quality. Signals having a lower value of quality can be ignored.

Multiple Base Station Spatial Multiplexing

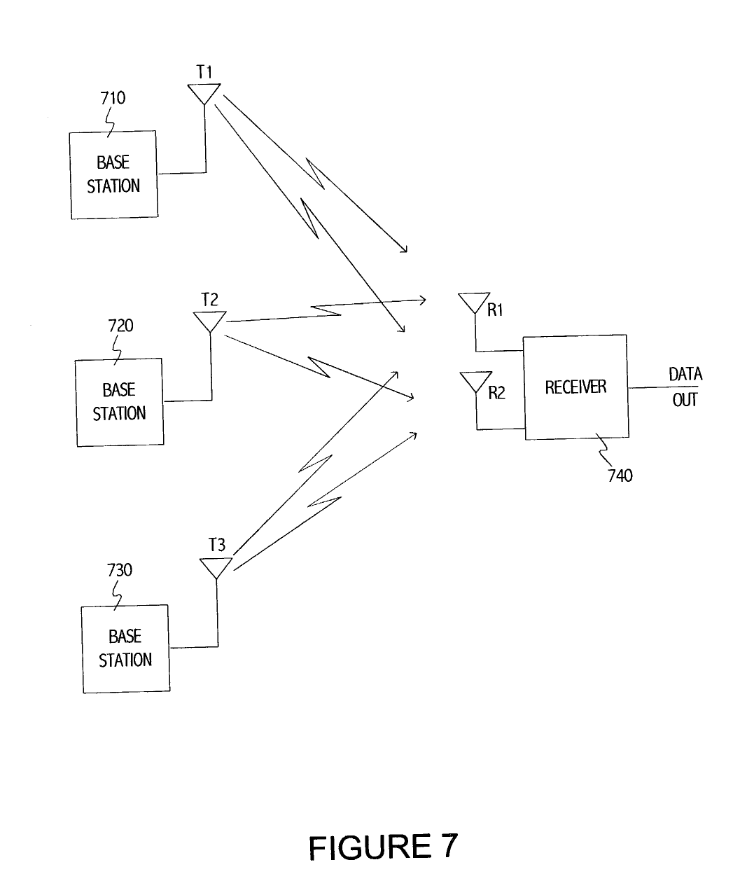

FIG. 7 shows an embodiment of the invention that includes multiple transmitting base stations 710, 720, 730. Each of the transmitting base stations 710, 720, 730 can include a corresponding transmit antenna T1, T2, T3. Each of the transmitting base stations 710, 720, 730 can transmit information to a receiver 740. The receiver can include multiple receiver antennae R1, R2. The invention can include any number of transmit and receive antennae.

The multiple transmitting base stations 710, 720, 730 can include spatial multiplexing transmission of diversity transmission. Because the transmitting base stations 710, 720, 730 are physically separated from each other, each of the transmission paths can be very different.

Each receiver chain of the receiver 740 can include the timing phase estimate biasing of the invention. An embodiment includes the receiver 740 receiving the quality parameter from a base transceiver station.

Multiple Carrier Systems

Frequency division multiplexing systems include dividing the available frequency bandwidth into multiple data carriers. OFDM systems include multiple carriers (or tones) that divide transmitted data across the available frequency spectrum. In OFDM systems, each tone is considered to be orthogonal (independent or unrelated) to the adjacent tones. OFDM systems use bursts of data, each burst of a duration of time that is much greater than the delay spread to minimize the effect of ISI caused by delay spread. Data is transmitted in bursts, and each burst consists of a cyclic prefix followed by data symbols, and/or data symbols followed by a cyclic suffix.

The bias control can be implemented by rotating the data segments with a circular phase shift. The previously described OFDM symbols include a cyclic prefix or cyclic suffix. Therefore, the data segments include circular properties. The bias can be implemented by circularly re-ordering the segmented data. The bias adjust can be made after the data has been segmented.

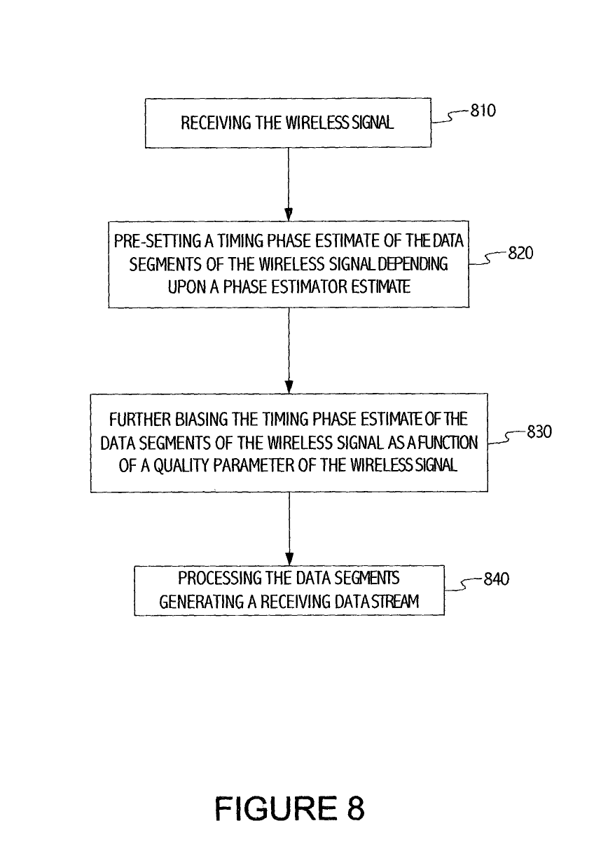

FIG. 8 shows a flow chart of steps or acts included within an embodiment of the invention. This embodiment includes a method of biasing a timing phase estimate of data segments of a received wireless signal.

A first step 810 includes receiving the wireless signal.

A second step 820 includes pre-setting a timing phase estimate of the data segments of the wireless signal depending upon a phase estimator estimate.

A third step 830 includes further biasing the timing phase estimate of the data segments of the wireless signal as a function of a quality parameter of the wireless signal.

A fourth step 840 includes processing the data segments generating a receiving data stream.

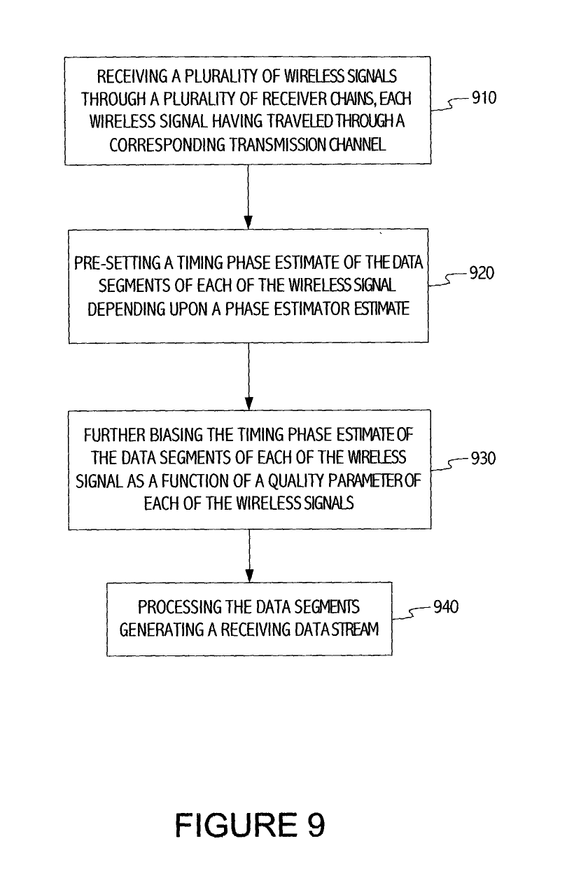

FIG. 9 shows a flow chart of steps or acts included within an embodiment of the invention. This embodiment includes a method of biasing a timing phase estimate of data segments of a received wireless signal.

A first step 910 includes receiving a plurality of wireless signals through a plurality of receiver chains, each wireless signal having traveled through a corresponding transmission channel.

A second step 920 includes pre-setting a timing phase estimate of the data segments of the each of the wireless signal depending upon a phase estimator estimate.

A third step 930 includes further biasing the timing phase estimate of the data segments of each of the wireless signal as a function of a quality parameter of each of the wireless signals.

A fourth step 940 includes processing the data segments generating a receiving data stream.

Although specific embodiments of the invention have been described and illustrated, the invention is not to be limited to the specific forms or arrangements of parts so described and illustrated. The invention is limited only by the claims.

What is claimed:

1. A method of biasing a timing phase estimate of data segments of a received wireless signal, comprising:
receiving the wireless signal;
pre-setting a timing phase estimate of the data segments of the wireless signal depending upon a phase estimator estimate;
further biasing the timing phase estimate of the data segments of the wireless signal as a function of a quality parameter of the wireless signal; and
processing the data segments generating a receiving data stream.

2. The method of biasing a timing phase estimate of data segments of a received wireless signal of claim 1, wherein the quality parameter of the wireless signal is a function of at least one of signal to noise ratio (SNR), channel delay profile, doppler spread, data segment phase estimate, a data segment phase algorithm, an equalizer length, cyclic prefix length, coding mode, a modulation mode, signal bandwidth, bit error rate (BER), packet error rate (PER), prior channel knowledge or error detection/correction codes.

3. The method of biasing a timing phase estimate of data segments of a received wireless signal of claim 1, wherein the biasing the phase of the data segments of the wireless signal as a function of a quality parameter of the wireless signal is additionally used by a transceiver receiving the wireless signal to adjust transmit timing phase of transmit data segments being transmitted by the transceiver.

4. The method of biasing a timing phase estimate of data segments of a received wireless signal of claim 1, wherein further biasing the timing phase estimate of the data segments of the wireless signal is additionally influenced by an external quality parameter received from a transmitter of the wireless signal.

5. The method of biasing a timing phase estimate of data segments of a received wireless signal of claim 1, further comprising:
receiving a plurality of wireless signals through a plurality of receiver chains, each wireless signal having traveled through a corresponding transmission channel;
pre-setting a timing phase estimate of the data segments of the each of the wireless signal depending upon a phase estimator estimate;
further biasing the timing phase estimate of the data segments of each of the wireless signals as a function of a quality parameter of each of the wireless signals; and
processing the data segments generating a receiving data stream.

6. The method of biasing a timing phase estimate of data segments of a received wireless signal of claim 5, wherein timing phase estimates of the data segments of each wireless signal are biased separately.

7. The method of biasing a timing phase estimate of data segments of a received wireless signal of claim 5, wherein the timing phase estimates of the data segments of all the wireless signal are biased with the same timing phase estimate.

8. The method of biasing a timing phase estimate of data segments of a received wireless signal of claim 5, wherein the quality parameter is a function of a composite of quality parameter of each of the plurality of the received signals.

9. The method of biasing a timing phase estimate of data segments of a received wireless signal of claim 5, wherein the quality parameter of each of the receiver chains is a function of a corresponding received signal of the receiver chains.

10. The method of biasing a timing phase estimate of data segments of a received wireless signal of claim 1, wherein the wireless signal is a multiple carrier signal.

11. The method of biasing a timing phase estimate of data segments of a received wireless signal of claim 10, wherein further biasing the timing phase estimate of the data segments of the wireless signal as a function of a quality parameter of the wireless signal comprises:
rotating the data segments with a circular phase shift.

12. The method of biasing a timing phase estimate of data segments of a received wireless signal of claim 1, further comprising:
receiving wireless signals from a plurality of separate transmitter antennas.

13. The method of biasing a timing phase estimate of data segments of a received wireless signal of claim 12, further comprising:
only processing the wireless signals that include a quality parameter having a threshold value of quality.

14. The method of biasing a timing phase estimate of data segments of a received wireless signal of claim 12, wherein the wireless signals are received from a plurality of base transceiver stations.

15. The method of biasing a timing phase estimate of data segments of a received wireless signal of claim 12, wherein a timing phase estimate of received signals are additionally biased as a function of whether the transmission includes spatial multiplexing.

16. The method of biasing a timing phase estimate of data segments of a received wireless signal of claim 12, wherein a timing phase estimate of received signals are additionally biased as a function of whether the transmission includes transmit diversity.

17. The method of biasing a timing phase estimate of data segments of a received wireless signal of claim 1, further comprising:
receiving the quality parameter from a base transceiver station.

18. A method of biasing a timing phase estimate of data segments of a received wireless signal, comprising:
receiving a plurality of wireless signals through a plurality of receiver chains, each wireless signal having traveled through a corresponding transmission channel;
pre-setting a timing phase estimate of the data segments of the each of the wireless signal depending upon a phase estimator estimate;
further biasing the timing phase estimate of the data segments of each of the wireless signal as a function of a quality parameter of each of the wireless signals; and
processing the data segments generating a receiving data stream.

19. The method of biasing a timing phase estimate of data segments of a received wireless signal of claim 18, wherein the quality parameter of the wireless signal is a function of at least one of signal to noise ratio (SNR), channel delay profile, doppler spread, data segment phase estimate, a data segment phase algorithm, an equalizer length, cyclic prefix length, coding bandwidth, a modulation bandwidth, bit error rate (BER), packet error rate (PER) or error detection/correction codes.

20. The method of biasing a timing phase estimate of data segments of a received wireless signal of claim 18, wherein the biasing the phase of the data segments of the wireless signal as a function of a quality parameter of the wireless signal is additionally used by a transceiver receiving data segments to adjust transmit timing phase estimates of transmit data segments being transmitted by the transceiver.

21. A system for biasing a timing phase estimate of data segments of a received wireless signal comprising:
means for receiving the wireless signal;
means for pre-setting a timing phase estimate of the data segments of the wireless signal depending upon a phase estimator estimate;
means for further biasing the timing phase estimate of the data segments of the wireless signal as a function of a quality parameter of the wireless signal; and
means for processing the data segments generating a receiving data stream.
